(19) United States
(12) Patent Application Publication
(10) Pub. No.: US 2016/0186981 A1
(43) Pub. Date: Jun. 30, 2016

(54) LAMP MODULE

(71) Applicants: CHAMP TECH OPTICAL (FOSHAN) CORPORATION, Foshan (CN); Foxconn Technology Co., Ltd., New Taipei (TW)

(72) Inventors: CHIN-CHUNG CHEN, Tu-Cheng (TW); CHENG-BING TAN, Foshan (CN)

(21) Appl. No.: 14/607,279

(22) Filed: Jan. 28, 2015

(30) Foreign Application Priority Data
Dec. 31, 2014 (CN) 201410847232.0

(51) Int. Cl. F21V 29/77; F21V 29/83; F21V 29/67; F21V 23/00

(52) U.S. Cl. CPC F21V 29/77; F21V 23/003; F21V 29/83; F21V 29/67; F21Y 2101/02

(57) ABSTRACT

A lamp module includes a lamp housing having a receiving space, a driver received in the receiving space of the lamp housing, a heat sink having a base portion at a front side and a fin portion at a back side, and a lighting module arranged at a front side of the base portion of the heat sink. A front end portion of the lamp housing couples to a back side of the base portion of the heat sink, and the fin portion of the heat sink surrounds the front end portion of the lamp housing.

### FIELD

The subject matter herein generally relates to a lamp module having a heat sink receiving a part of lamp housing of the lamp module.

### BACKGROUND

A typical lamp module includes a lamp housing, a connector located at a side of the lamp housing, a light source located at an opposite side of the lamp housing and a lamp cover covering the light source. In order to dissipate the heat generated from the light source, a heat sink and a fan are usually provided. However, in the typical lamp module, the heat sink is located inside of the lamp housing or the lamp cover, which decreases the heat dissipating efficiency of the lamp module.

### BRIEF DESCRIPTION OF THE DRAWINGS

Implementations of the present technology will now be described, by way of example only, with reference to the attached figures.

FIG. 1 is an isometric view of a lamp module in accordance with an exemplary embodiment of the present disclosure.

FIG. 2 is an exploded view of the lamp module of FIG. 1.

FIG. 3 is an inverted view of the lamp module of FIG. 2.

FIG. 4 is an isometric view of a heat sink of the lamp module.

FIG. 5 is a cross sectional view of the lamp module of FIG. 1, taken along a V-V line.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

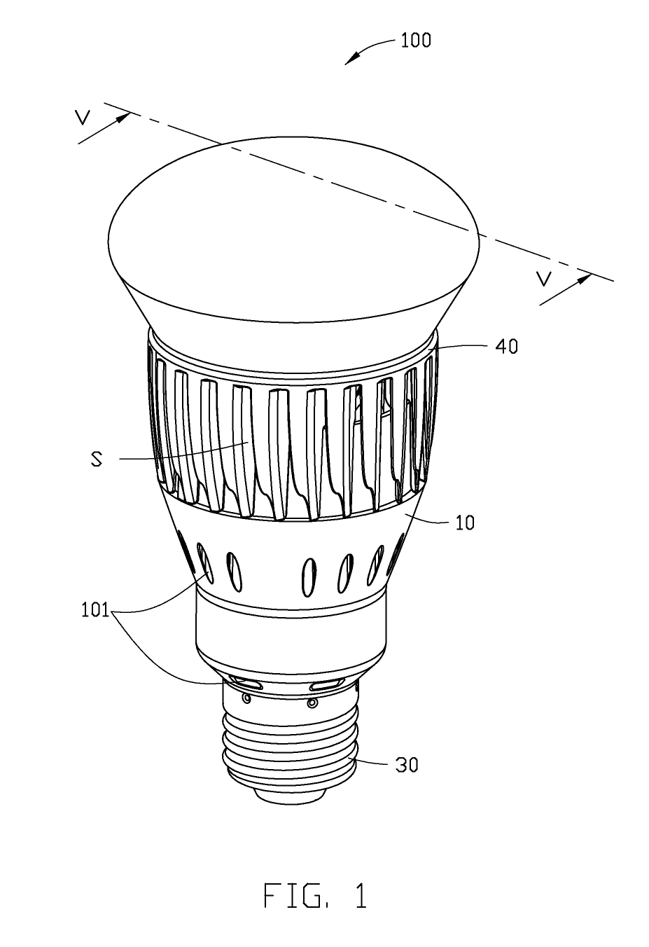

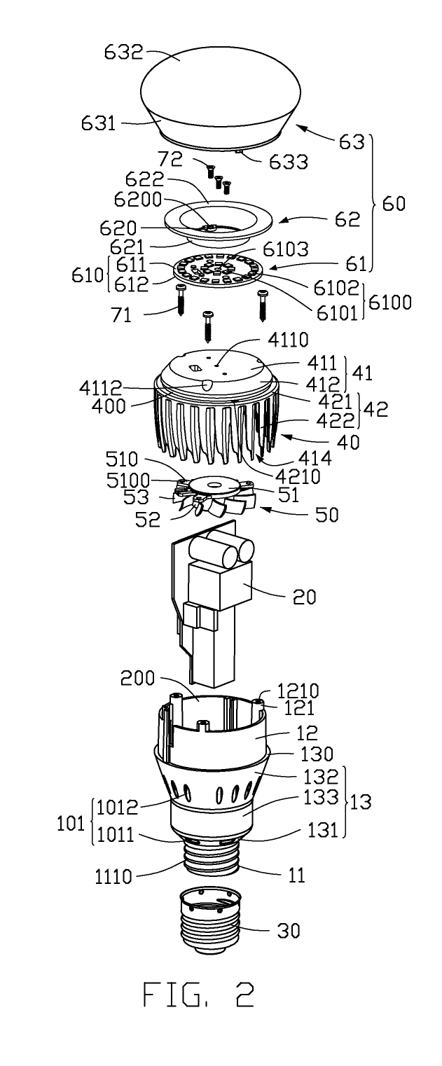

FIG. 1 and FIG. 2 illustrate a lamp module 100 in accordance with an embodiment of the present disclosure. The lamp module 100 has a lamp housing 10, a driver 20 received in the lamp housing 10, a connector 30 located at an end of the lamp housing 10, a heat sink 40 located at an opposite end of the lamp housing 10, a fan 50 coupling with the heat sink 40, and a lighting module 60 coupling with the heat sink 40. The heat sink 40 receives the opposite end of the lamp housing 10, and a part of the heat sink 40 is exposed out of the lamp housing 10.

The lamp housing 10 has a plurality of air inlets 101. The heat sink 40 has a plurality of air outlets S communicating with the air inlets 101 of the lamp housing 10. The fan 50 drives air to flow into the lamp housing 10 from the air inlets 101 and then flow out of the lamp housing 10 from the air outlets S of the heat sink 40.

The lamp housing 10 includes a back end portion 11, a front end portion 12 opposite to the back end portion 11 and a connecting portion 13 located between the back end portion 11 and the front end portion 12. The lamp housing 10 has a receiving space 200 in middle of the lamp housing 10. The receiving space 200 penetrates through the back end portion 11, the connecting portion 13 and the front end portion 12 along a longitudinal direction of the lamp housing 10. The receiving space 200 of the lamp housing 10 can receive the driver 20. The driver 20 can be a circuit at least having a transformer and a voltage stabilizer.

The air inlets 101 are defined in the connecting portion 13 to communicate with the receiving space 200.

In this embodiment, the connector 30 is coupled with the back end portion 11. The heat sink 40, the fan 50 and the lighting module 60 are coupled with the front end portion 12 of the lamp housing 10.

The back end portion 11 can be cylindrical. Screw threads 1110 can be formed at an outer periphery of the back end portion 11. And the connector 30 is in a screwing connection with the back end portion 11.

The connecting portion 13 includes a first connecting portion 131 connecting the back end portion 11, a second connecting portion 132 connecting the front end portion 12, and a middle portion 133 located between the first connecting portion 131 and the second connecting portion 132.

The first connecting portion 131 extends upwardly and slantwise from a top periphery of the back end portion 11. A size of the first connecting portion 131 increases from a bottom end to a top end. A plurality of first air inlets 1011 are defined in the peripheral sides of the first connecting portion 131. The plurality of first air inlets 1011 communicates with the receiving space 200. Preferably, the plurality of the first air inlets 1011 are equidistantly arranged at the peripheral sides of the first connecting portions 131. The plurality of the first air inlets 1011 is adjacent to the connector 30, which increases airflow near the connector 30.

The middle portion 133 extends vertically and upwardly from a top periphery of the first connection portion 131 to be a cylindrical configuration.

The second connecting portion 132 extends upwardly and outwardly from a top periphery of the middle portion 133. A size of the second connecting portion 132 increases from a bottom end to a top end. A plurality of second air inlets 1012 are defined in peripheral sides of the second connecting portion 132. The plurality of second air inlets 1012 communicates with the receiving space 100. The plurality of second air inlets 1012 is located above the plurality of the first air inlets 1011. A size of each second air inlet 1012 is larger than a size of each first air inlet 1011. The number of the second air inlets 1012 is larger than that of the first air inlets 1011. In this embodiment, the first air inlets 1011 and the second air inlets 1012 cooperatively defines the air inlets 101 of the lamp housing 10.

The lamp housing 10 further has a supporting portion 130. The supporting portion 130 is located between the front end portion 12 and the connecting portion 13. The supporting portion 130 can extends inward from the top periphery of the second connecting portion 132. The second portion 12 upwardly extends from the inner periphery of the supporting portion 130. In at least one embodiment, the supporting portion 130 is plane.

The lamp housing 10 can have a plurality of first fixing portions 121. The first fixing portion 121 can be located on the outer end of the front end portion 12. The plurality of first fixing portions 121 extends outwardly from the outer end of the front end portion 12. The first fixing portions 121 are spaced from each other. The first fixing portions 121 can be equidistantly spaced from each other. In this embodiment, the lamp housing 10 has three first fixing portions 121. A first fixing cavity 1210 is defined in a middle portion of each first fixing portion 121. The first fixing cavity 1210 extends along a height direction of each first fixing portion 121 without passing through the first fixing portion 121.

The heat sink 40 is coupled to an end of the lamp housing 10. In this embodiment, the heat sink 40 is coupled to the front end portion 12 of the lamp housing 10. The heat sink 40 includes a base portion 41 and fin portion 42 on a side of the base portion 41. The heat sink 40 has an annular slot 400 at an outer periphery of the heat sink 40. The annular slot 400 can be defined between the base portion 41 and the fin portion 42.

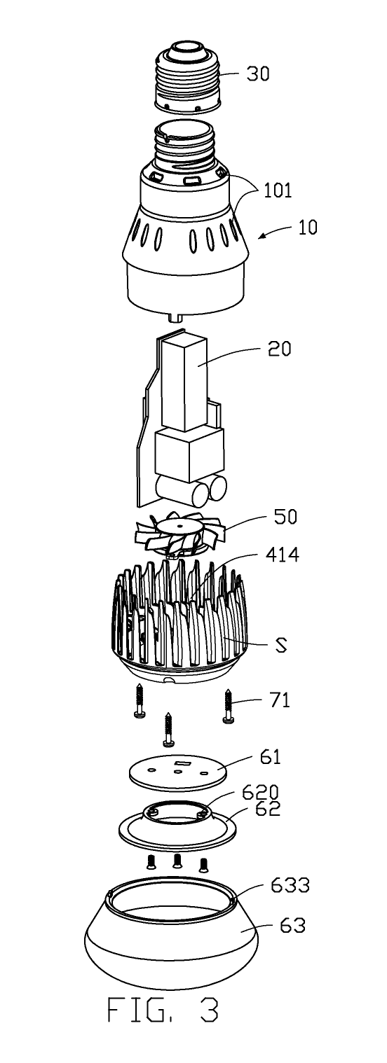

Referring to FIG. 2 and FIG. 3, the base portion 41 includes a top plate 411 and a side wall 412 downwardly extending from a periphery of the top plate 411. The top plate 411 has a front side configured for supporting the lighting module 60, and a back side opposite to the front side. The top plate 411 and the side wall 412 cooperatively define a receiving cavity 414 at a back side of the top plate 411, which is configured to receive the fan 50.

The heat sink 40 has a plurality of first fixing holes 4110 defined through the top plate 411. The first fixing holes 4110 are arranged in a line. In this embodiment, the heat sink 40 has three first fixing holes 4110. Preferably, one first fixing hole 4110 penetrates through the central portion of the top plate 411, the other two first fixing holes 4110 are at opposite sides of the one first fixing hole 4110.

The heat sink 40 further has a plurality of second fixing holes 4112 defined at a periphery of the top plate 411. In this embodiment, the heat sink 40 has three second fixing holes 4112 which are equidistantly spaced from each other.

The fin portion 42 has a base 421 and a plurality of fins 422 extending downwardly from a back side of the base 421. The base 421 can be an annular plate. The fin portion 42 has a plurality of receiving cavities 4210 defined at a periphery of the base 421. The receiving cavities 4210 are spaced from each other.

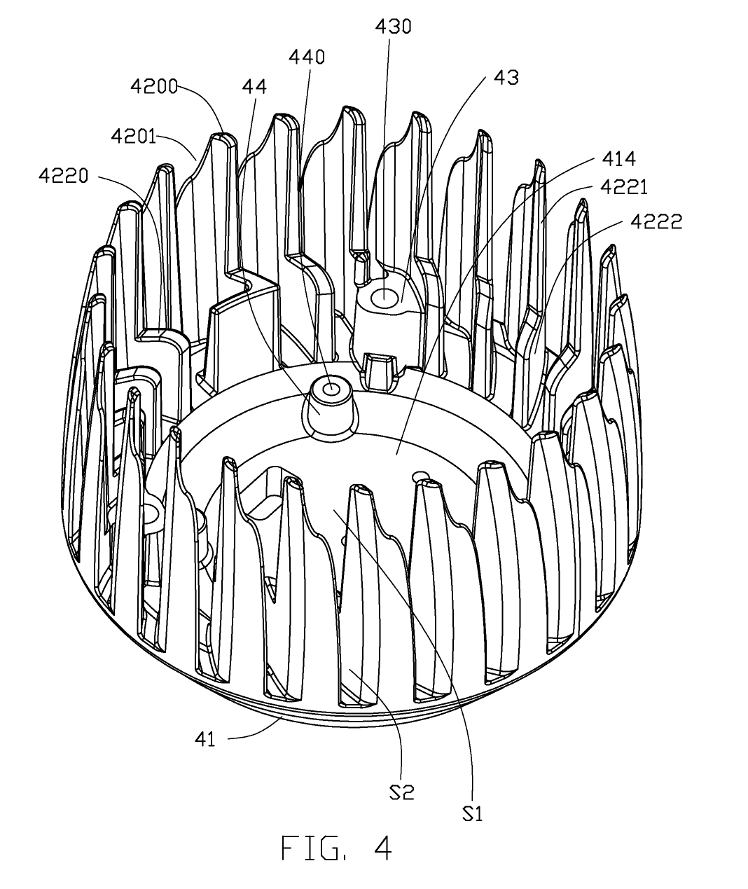

Referring to FIG. 4, the fins 422 each has a first fin 4221 and a second fin 4222 extending from the first fin 4221. The first fins 4221 are spaced from each other, and are located at a back side of the base 421. The second fins 4222 inwardly extend from inner sides of the first fins 4221. A height of the second fins 4222 is less than that of the first fins 4221. A step portion 4220 is defined by the first fins 4221 and the top end of the second fins 4222. The first fins 4221 and the second fins 4222 can be formed as a single piece. A cut 4201 is defined at a top end of each first fins 4221. The cut 4201 can be arc-shaped.

A first channel S1 is defined between two adjacent first fins 4221, and a second channel S2 is defined between two adjacent second fins 4222. The first channel S1 communicates with the second channel S2 to corporately define the air outlets S. A width of the first channel S1 is less than that of the second channel S2. The fins 422 can be arc-shaped.

The heat sink 40 further has a plurality of first fixing parts 43. The first fixing parts 43 are located between each two adjacent fins 422. The first fixing parts 43 can be cylindrical. A height of each first fixing part 43 is less than that of the second fin 4222. The first fixing part 43 each has a first fixing cavity 430 defined in a middle portion of the fixing part 43.

The heat sink 40 further has a plurality of second fixing parts 44. The second fixing parts 44 are adjacent to the inner wall of the receiving cavity 414. The height of the second fixing parts 44 can be equal to the depth of the receiving cavity 414. The second fixing parts 44 each has a second fixing cavity 440 defined in a middle portion.

Referring to FIG. 2, the fan 50 is located at the back side of the heat sink 40. The fan 50 can be received in the receiving cavity 414. The fan 50 has a plate 51, a hub 52 located at a side of the plate 51, and a plurality of blades 53 extending from the outer periphery of the hub 52. The fan 50 further has a plurality of arms 510 outwardly extending from the periphery of the plate 51. The plurality of arms 510 are spaced from each other. A through hole 5100 is defined through an outer end of each arm 510.

The lighting module 60 has a light source 61, a reflector 62 and a lamp cover 63 configured to cover the light source 61 and the reflector 62.

The light source 61 has a circuit board 610 and a plurality of lighting elements 6100 electrically coupling with the circuit board 610. In this embodiment, the circuit board 610 has a circular configuration. The lighting elements 6100 can be light emitting diodes.

The circuit board 610 has a front face 611 and a back face 612 opposite to the front face 611. The plurality of lighting elements 6100 are arranged on the front face 611 of the circuit board 610. The back face 612 of the circuit board 610 is attached to the top plate 411 of the heat sink 40.

The lighting elements 6100 include a plurality of first lighting elements 6101 and a plurality of second lighting elements 6102. The first lighting elements 6101 are located in a central portion of the circuit board 610. The second lighting elements 6102 are located at an outer periphery of the circuit board 610 to surrounding the first lighting elements 6101.

The circuit board 610 further has a plurality of through holes 6103. The number of the through holes 6103 can be three. At least one of the through holes 6103 penetrates through the center of the circuit board 610. The through holes 6103 can be aligned with each other.

The reflector 62 is located on the front side of the circuit board 610. The reflector 62 has a side wall 621 and a top wall 622 extending outerwardly from a periphery of the side wall 621. The side wall 621 surrounds the first lighting elements 6101. The side wall 621 is located between the first lighting elements 6101 and the second lighting elements 6102. The side wall 621 is surrounded by the second lighting elements 6102. The top wall 622 is located above the second lighting elements 6102. The top wall 622 blocks light from the second lighting elements 6102 to periphery sides of the reflector 62. In this embodiment, a size of the reflector 62 gradually increases from a bottom end to the top end. An outer surface of the reflector 62 facing the second lighting elements 6102 is curved. And the outer surface of the reflector 62 can be arc-shaped.

The reflector 62 further includes a plurality of locking portions 620. The reflector 62 can have two locking portions 620. The locking portions 620 extend horizontally and inwardly from the bottom end of the reflector 62. The locking portions 620 are spaced from each other. The locking portions 620 are aligned with each other. A passing hole 6200 passes through each locking portion 620.

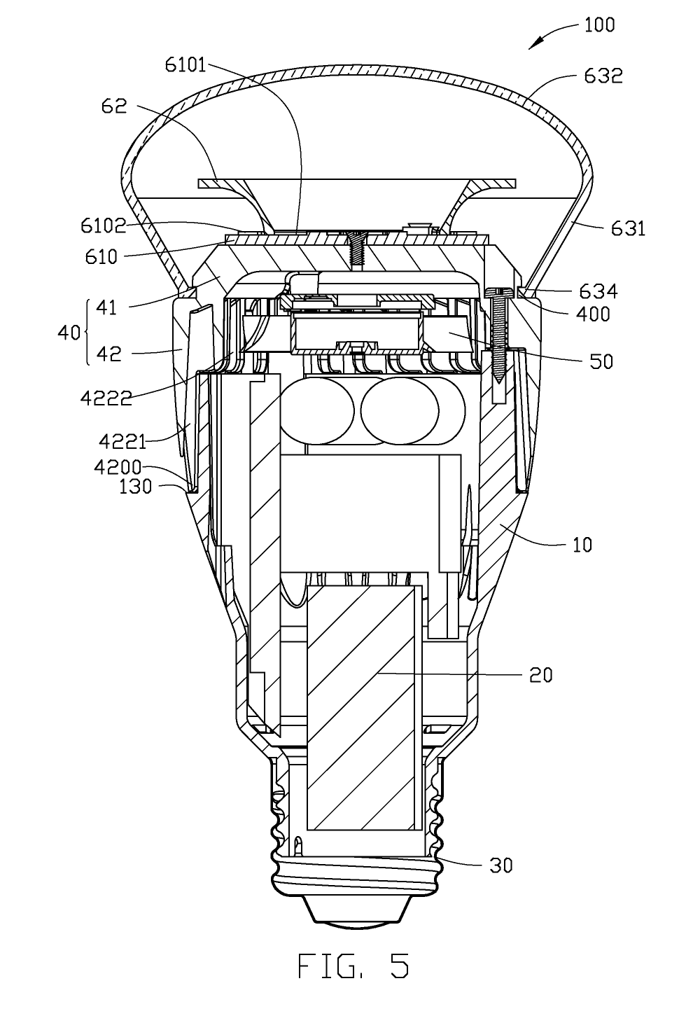

Referring to FIG. 2 and FIG. 5, the lamp cover 63 couples with the heat sink 40 to cover the light source 61 and the reflector 62. The lamp cover 63 covers the base portion 41 of the heat sink 40, and the fin portion 42 is exposed out of the lamp cover 63. The fin portion 42 surrounds the front end portion 12 of the lamp housing 10.

The lamp cover 63 includes a surrounding wall 631 and a top wall 632 sealing the top end of the surrounding wall 631. The lamp cover 63 also includes a plurality of locking parts 633 located at a bottom end. The locking parts 633 are configured to lock with the heat sink 40. The lamp cover 63 is made of transmitting materials.

The lamp cover 63 can further have a hook 634, which is corresponding with the annular slot 400 between the base portion 41 and the fin portion 42. The hook 634 can be received into the annular slot 400.

When assembling the lamp module 100, the connector 30 can couple with the back end portion 11 of the lamp housing 10. A plurality of first locking pieces 71 respectively penetrates through the second fixing holes 4112 of the base portion 41, and the first fixing cavity 1210 of the front end portion 12 to combine the heat sink 40 with the lamp housing 10. The fin portion 42 surrounds the second portion 12 of the lamp housing 10. The outmost end 4200 of the fin portion 42 abuts the supporting portion 130 of the lamp housing 10. A plurality of second locking pieces 72 penetrates through the passing hole 6200 of the locking portions 620 of the reflector 62, the through holes 6103 of the circuit board 610, and the first fixing holes 4110 of the top plate 411 of the heat sink 40 to combine the reflector 62 and the light source 61 with the heat sink 40. Further, the locking parts 633 are respectively received into the receiving cavities 4210 of the base 421 of the fin portion 42.

The embodiments shown and described above are only examples. Many details are often found in the art such as the other features of a lamp module. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A lamp module comprising:
a lamp housing defining a receiving space;
a driver configured to be received in the receiving space of the lamp housing;
a heat sink connected to the lamp housing having a base portion at a front side and a fin portion at a back side; and
a lighting module arranged at a front side of the base portion of the heat sink;
wherein a front end portion of the lamp housing is received into a back side of the base portion of the heat sink, and the fin portion of the heat sink surrounds the front end portion of the lamp housing and is disposed out of the lamp housing.

2. The lamp module of claim 1, wherein the lamp housing has a plurality of air inlets communicating with the receiving space and the heat sink has a plurality of air outlets communicating with the air inlets of the lamp housing.

3. The lamp module of claim 2, wherein the air inlets have a plurality of first air inlets and a plurality of second air inlets located above the first air inlets, and the number of the first air inlets is less than the number of the second air inlets.

4. The lamp module of claim 2, wherein the heat sink has a receiving cavity in a back side of the base portion, and a fan is received in the receiving cavity.

5. The lamp module of claim 1, wherein the lamp housing has a supporting portion located at an outer surface of the lamp housing, and an outermost end of the fin portion abuts the supporting portion of the lamp housing.

6. The lamp module of claim 1, wherein the fin portion has a plurality of curved fins at a periphery of a back side of the fin portion.

7. The lamp module of claim 6, wherein the fins has a plurality of first fins and a plurality of second fins extending inwardly from the inner sides of the first fins, and a height of each first fin is larger than that of each second fin.

8. The lamp module of claim 7, wherein a first channel is defined between each two adjacent first fins, and a second channel is defined between each two adjacent second fins, and a width of the first channel is less than that of the second channel.

9. The lamp module of claim 6, wherein each fin has a cut at an outer most end thereof.

10. The lamp module of claim 9, wherein the cut is arc-shaped.

11. The lamp module of claim 1, wherein the lighting module has a circuit board with a front face and a back face opposite to the front face and a plurality of lighting elements located on the front face, the back face of the circuit is directly attached to the front side of the base portion of the heat sink.

12. The lamp module of claim 11, wherein the lighting elements has a plurality of first lighting elements located at a central portion of the circuit board and a plurality of second lighting elements located at a periphery of the circuit board to surround the first lighting elements.

13. The lamp module of claim 12, wherein the lighting module further has a reflector located between the first lighting elements and the second lighting elements, and an inner surface of the reflector surrounds the first lighting elements, and an outer surface of the side wall is surrounded by the second lighting elements.

14. The lamp module of claim 11, wherein the lighting module further has a lamp cover, the lamp cover covers the base portion of the heat sink and the fin portion of the heat sink is disposed out of the lamp housing.

15. The lamp module of claim 14, wherein the lamp cover has a hook located at a bottom periphery, the heat sink has a slot defined between the base portion and the fin portion, and the hook is received into the slot to combine the lamp cover with the heat sink.

16. The lamp module of claim 14, wherein the lamp cover has a plurality of locking parts located at a bottom periphery, the heat sink has a plurality of receiving cavities corresponding to the locking parts in the base portion, and the plurality of locking parts are received into the receiving cavities of the base portion.

17. The lamp module of claim 13, wherein the lighting module further has a lamp cover, the lamp cover covers the base portion of the heat sink and the fin portion of the heat sink is disposed out of the lamp housing.

18. A lamp module comprising:
a lamp housing defining a receiving space;
a driver received in the receiving space;
a heat sink having a base portion at a front side and a fin portion at a back side opposite to the front side;
a light source located on the base portion of the heat sink and can be driven to work by the driver; and
a lamp cover covering the light source;
wherein the lamp cover covers the base portion of the heat sink and the fin portion of the heat sink are disposed out of the lamp cover.

19. The lamp module of claim 18, wherein the fin portion has a plurality of spaced fins surrounding a front end portion of the lamp housing.

20. The lamp module of claim 19, wherein the lamp housing has a plurality of air inlets communicating with the receiving space, the heat sink has a plurality of air outlets between the fins communicating with the receiving space, and a fan is received into a back side of the base portion of the heat sink.
